(19) United States
(12) Patent Application Publication
(10) Pub. No.: US 2016/0138914 A1
(43) Pub. Date: May 19, 2016

(54) SYSTEM AND METHOD FOR ANALYZING DATA

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZHI-YA LI, Shenzhen (CN); ZONG-TAO YANG, Shenzhen (CN)

(21) Appl. No.: 14/796,233

(22) Filed: Jul. 10, 2015

(30) Foreign Application Priority Data
Nov. 13, 2014 (CN) 201410639835.1

(51) Int. Cl. G01B 21/20; G01B 21/30

(52) U.S. Cl. CPC G01B 21/20; G01B 21/30

(57) ABSTRACT

The present disclosure provides a system and a method for analyzing graphical data of an object. The system is implemented on a computing device linked to a database. The system receives a point cloud file corresponding to the object from the database, extracts point cloud data from the point cloud file, and meshes point cloud data to generate coordinate data corresponding to vertices for a plurality of meshed triangles. The system calculates distances between each of the meshed triangles and a fitting plane and a normal vector for each meshed triangle. The system calculates an included angle between the normal vector of each meshed triangle and a normal vector of the fitting plane to determine the accuracy of the point cloud data patches, and generates a report containing an accuracy analysis of the point cloud data for the object and a point cloud statistical analysis report.

### CROSS-REFERENCE TO RELATED APPLICATIONS

This application claims priority to Chinese Patent Application No. 201410639835.1 filed on Nov. 13, 2014, the contents of which are incorporated by reference herein.

### FIELD

The subject matter herein generally relates to a system and a method for analyzing data representing the surface information of an object.

### BACKGROUND

Manufacturing precision has always been one of main concerns in a typical manufacturing industry, as manufacturing precision directly affects the overall product quality and the safety of a product. It is generally difficult to obtain detail and accurate understanding as to manufacturing accuracy after a product has been processed in a manufacturing process. Even though current technology supports product scanning operation, scanning a product can only provide the point cloud data associated with the product scanned which is a very limited information and not very useful for analyzing the overall manufacturing quality of the product. Most of conventional computer-aided design (CAD) systems are designed to apply basics arithmetic processing operations to the point cloud data and calculate 2D information for the product. However, there has not been a system designed to analyze the accuracy of the point cloud data. For industries that demand high-level manufacturing precision, plain 2D information is far from sufficient and cannot accurately provide detail information as to the manufacturing precision of a product. Moreover, not only do the current CAD systems only provide basic point cloud processing functionalities, but the point cloud processing algorithm employed in current CAD systems has low accuracy. Current CAD systems can only provide basic and limited point cloud information to simple figures, and are unable to analyze and process complex figures or figures with irregular shapes.

### SUMMARY

Accordingly, there is a need to provide a system and a method for analysis which tests the point cloud data for high accuracy through analyzing the point cloud data associated with the object.

An exemplary embodiment of the present disclosure provides a system for analyzing data of an object and the system is operated on a computing device, wherein the computing device is linked to a database. The system includes a meshing module, a plan fitting module, a distance calculation module, a normal vector computing module, and a color-coding module. The meshing module is configured to obtain a point cloud file corresponding to the object from the database and extracts a first point cloud data from the data file. The meshing module further is configured to mesh the first point cloud data based on a triangular meshing algorithm to generate a second point cloud data, wherein the second point data contains coordinate data corresponding to the vertices for a plurality of meshed triangles. The plane fitting module is configured to generate a fitting plane based on the second point cloud data received from the point cloud mesh generation module, and calculate a normal vector of the fitting plane thereafter. The distance calculation module is configured to calculate the distance between each of the meshed triangles recorded in the second point cloud data and the fitting plane. The normal vector calculation module is configured to calculate the normal vector for each meshed triangle. The normal vector calculation module further determines whether each of the meshed triangles satisfies an accuracy evaluation criterion according to the normal vector of the respective meshed triangle and the normal vector of the fitting plane. The color-coding module is configured to operatively color each of the meshed triangles to satisfy the accuracy evaluation criterion, using different colors based on the distances calculated between the respective meshed triangle and the fitting plane to indicate different accuracy levels.

In one embodiment, the accuracy evaluation criterion includes determining whether an included angle between the normal vector of that meshed triangle and the normal vector of the fitting plane is less than 90 degrees.

Another exemplary embodiment of the present disclosure provides a method for analyzing data of an object. The method is implemented on a computing device, which is linked to a database. The method includes the following steps. A point cloud file is received from the database. Subsequently, first point cloud data is extracted from the point cloud file. The first point cloud data is further meshed based on a triangular meshing algorithm to generate a second point cloud data, wherein the second point cloud data contains coordinate data corresponding to the vertices for a plurality of meshed triangles. Next, a fitting plane is generated based on the second point cloud data and a normal vector of the fitting plane is calculated. The distance between each meshed triangle and the fitting plane is calculated and a normal vector for each meshed triangle in the second point cloud data is calculated thereafter. Whether each of the meshed triangles satisfy an accuracy evaluation criterion is next determined according to the normal vector of the meshed triangle and the normal vector of the fitting plane. Meshed triangles that satisfy the accuracy evaluation criterion are differently colored to indicate different levels of accuracy thereafter.

In one embodiment, whether the meshed triangle satisfies the accuracy evaluation criterion is determined by whether the included angle between the normal vector of the meshed triangle and the normal vector of the fitting plane is less than 90 degrees.

An exemplary embodiment of the present disclosure provides a non-transitory computer-readable medium, for storing a computer executable program codes for the aforementioned a method for analyzing a graphical data for an object. The codes can be read and executed by a processor of a computer.

The disclosure generates a fitting plane with high precision, through analyzing the point cloud data corresponding to the object, using high-accuracy fitting algorithm and processing the point cloud data to generate detail analysis of the accuracy of the point cloud data. In particular, the system is operable to provide an accuracy analysis report for point cloud data and a point cloud data analysis report. The point cloud data accuracy analysis report describes different accuracy levels associated with the point cloud data using different color markings, and the point cloud data analysis report provides detail description associated with the point cloud data. The system provides a relatively simple and more direct method to indicate the accuracy of the processed object (e.g., a manufactured product), to serve as a useful tool or reference for manufacturing process calibration.

The following descriptions and appended drawings are referred to such that, all the purposes, features, and aspects of the present disclosure can be understood. However, the appended drawings are merely provided for reference and illustration, with no intention of limiting the scope of the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram illustrating a system for analyzing data provided in accordance to an exemplary embodiment of the present disclosure.

FIG. 2 is a flowchart illustrating a method for analyzing data provided in accordance to an exemplary embodiment of the present disclosure.

FIG. 3 is a diagram illustrating an exemplary representation of a point cloud file provided in accordance to an exemplary embodiment of the present disclosure.

FIG. 4 is a diagram illustrating a triangular meshing operation provided in accordance to an exemplary embodiment of the present disclosure.

FIG. 5 is a diagram illustrating an operation of color-coding meshed triangles to satisfy specific conditions in accordance to an exemplary embodiment of the present disclosure.

FIG. 6 is a diagram illustrating an analysis report containing point cloud data provided in accordance to an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the equivalents.

The drawings are not necessarily to scale and the proportions of certain parts may be exaggerated to better illustrate details and features. The description is not to be considered as limiting the scope of the embodiments described herein.

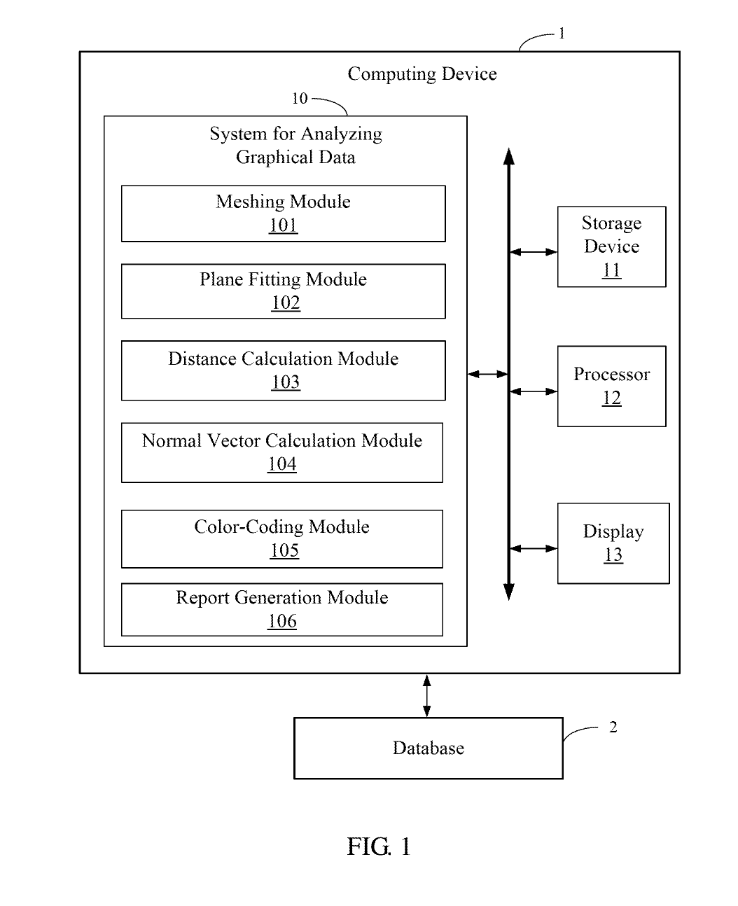

FIG. 1 shows a system for analyzing graphical data provided in accordance to an exemplary embodiment of the present disclosure. In the instant embodiment, a system for analyzing surface data 10 (hereinafter “the system 10”) is installed and operated on a computing device 1. The computing device 1 includes but not limited to being a personal computer, a workstation computer, a laptop, a server, or any other equivalent computing device. The computing device 1 in the instant embodiment includes a storage device 11, a processor 12, and a display 13. The system 10 is connected to the storage device 11, the processor 12, and the display 13 via a data bus. The computing device 1 has an operating system (e.g., Windows or Linux) and at least one application program (e.g., CAD graphical software) installed thereon.

The computing device 1 is linked to a database 2 via a cable or an Ethernet cable (e.g., WAN or LAN cable). The database 2 is configured to store at least one point cloud file corresponding to an object under analysis. The object may include, but not limited to being a manufactured product (e.g., an electronic product or a component of the manufactured product).

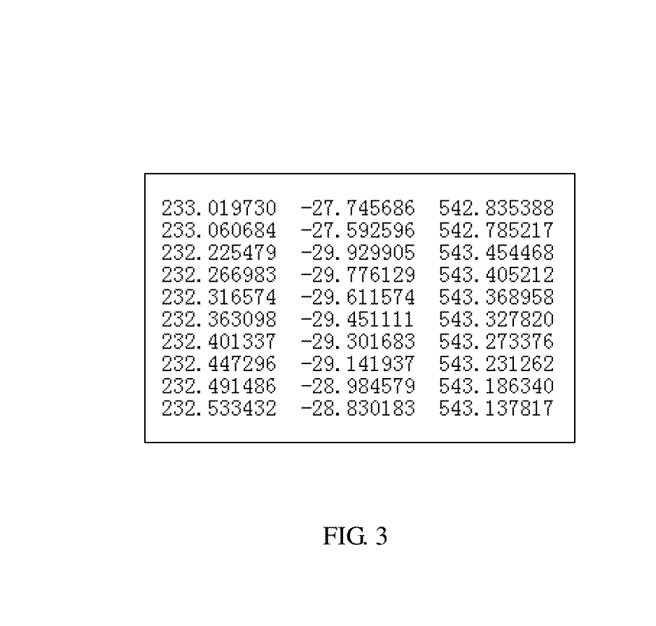

The point cloud file (shown in FIG. 3) is a file containing point cloud data corresponding to the object as measured in a coordinate system (e.g., a Cartesian coordinate system). Specifically, the point cloud file may contain spatial coordinate data corresponding to the object under analysis. In one embodiment, the point cloud data of the object may be a set of vertices in a two-dimensional (2D) or three-dimensional (3D) coordinate system.

The point cloud data may be generated by physically scanning structure of the object under analysis with a scanner (not shown) and stored in a file (i.e., the point cloud file) in the database 2, for the system 10 to access during operation. The scanner may be connected to the computing device or the database 2. The scanner may be a laser scanner or any other scanning device known in the art, capable of scanning 2D and 3D objects and generating corresponding point cloud data.

The storage device 11 is configured to store processing data of the system 10 and the processor 12. The storage device 11 includes but is not limited to, a memory, a hard disk, and an external storage device. The storage device 11 may be implemented by a volatile or nonvolatile memory chip including but not limited to a flash memory chip, a read-only memory chip, or a random access memory chip. The present disclosure is not limited to the example storage device provided herein.

The processor 12 is the main operational core of the computing device 1 and is programmed to execute one or more computerized operations of the computing device 1 and other applications, to control the overall operation of the computing device 1. The processor 12 in the instant embodiment may be implemented by a central processing unit (CPU), a microcontroller, or a data processor programmed with necessary firmware. The present disclosure is not limited to the computing example provided herein.

The display 13 is configured to display a graphical representation of the object, and the point cloud accuracy and statistical analysis report for a user to view.

It should be understood that FIG. 1 merely illustrates an implementation of the computing device 1, other implementations may include fewer or more components than illustrated, or have a different configuration of the various components in other embodiments.

The system 10 is operable to receive a point cloud file corresponding to the object from the database 2 and to analyze the accuracy of the point cloud data associated with the object.

The system 10 includes a meshing module 101, a plane fitting module 102, a distance calculation module 103, a normal vector calculation module 104, a color-coding module 105, and a report generation module 106. The object under analysis may have (as in the instant disclosure) one point cloud file for simplicity, in practice, there may be one or more than one point cloud file associated with the object based on the structural complexity of the object and/or object analysis requirements. The present disclosure does not limit the number of files that the system 10 can retrieve from the database 2 for the analysis of the object.

The meshing module 101 is operable to obtain the point cloud file corresponding to the object, extract a first point cloud data from the point cloud file obtained, and perform a meshing operation on the first point cloud data. The meshing module 101 in the instant embodiment meshes the first point cloud data into a second point cloud data, based on a triangular meshing algorithm. More specifically, the meshing module 101 meshes the first point cloud data in such a manner that a circumscribed circle of any meshed triangle does not include any other vertices. The second point cloud data contains coordinate data corresponding to vertices for a plurality of meshed triangles generated after the meshing operation. A circumscribed circle is defined as a circle that includes all vertices of a corresponding meshed triangle.

The plane fitting module 102 is configured to generate a fitting plane based on the second point cloud data received from the point cloud mesh generation module 101 and calculate the normal vector for the fitting plane generated. The plane fitting module 102 may store the normal vector of the fitting plane in the storage device 11 for further processing.

The distance calculation module 103 is configured to calculate any distances which exist between each of the meshed triangle recorded in the second point cloud data and the fitting plane.

The normal vector calculation module 104 is configured to calculate a normal vector associated with each meshed triangle. The normal vector calculation module 104 may further store the normal vector of the fitting plane in the storage device 11 for further processing. The normal vector calculation module 104 operatively determines which of the meshed triangles satisfy an accuracy evaluation criterion. The accuracy evaluation criterion in the instant embodiment may be whether an included angle between the normal vector of each meshed triangle and the normal vector of the fitting plane is less than 90 degrees.

The color-coding module 105 is configured to color-code the meshed triangles that do satisfy the accuracy evaluation criterion. Different colors may be used based on the different distances between the each meshed triangle and the fitting plane, to indicate different accuracy levels.

Specifically, when the included angle between the normal vector of the respective meshed triangle and the normal vector of the fitting plane is calculated to be greater than 90 degrees, this indicates that the particular meshed triangle does not satisfy the accuracy evaluation criterion. Such a meshed triangle is to be neglected and no further process will be performed thereon.

When the included angle between the normal vector of the respective meshed triangle and the normal vector of the fitting plane is calculated to be less than 90 degrees, this indicates that the respective meshed triangle satisfies the accuracy evaluation criterion. The color-coding module 105 color-codes such a meshed triangle according to the distance between the respective meshed triangle and the fitting plane.

The color-coding module 105 further configured to generate a color gradient bar indicating different distances between each meshed triangle and the fitting plane, and the color gradient bar contains color-coding information corresponding to meshed triangles having different distances to the fitting plane.

The report generation module 106 is coupled to the color-coding module 105. The report generation module 106 generates an accuracy analysis report as to the color-coding result of the meshed triangles, indicating in report form an accuracy indication of the second point cloud data, and a point cloud data analysis report as to the statistical analysis result of the second point cloud data. The report generation module 106 may include the color gradient bar in the report for providing a more direct and visual understanding as to the accuracy of the point cloud data.

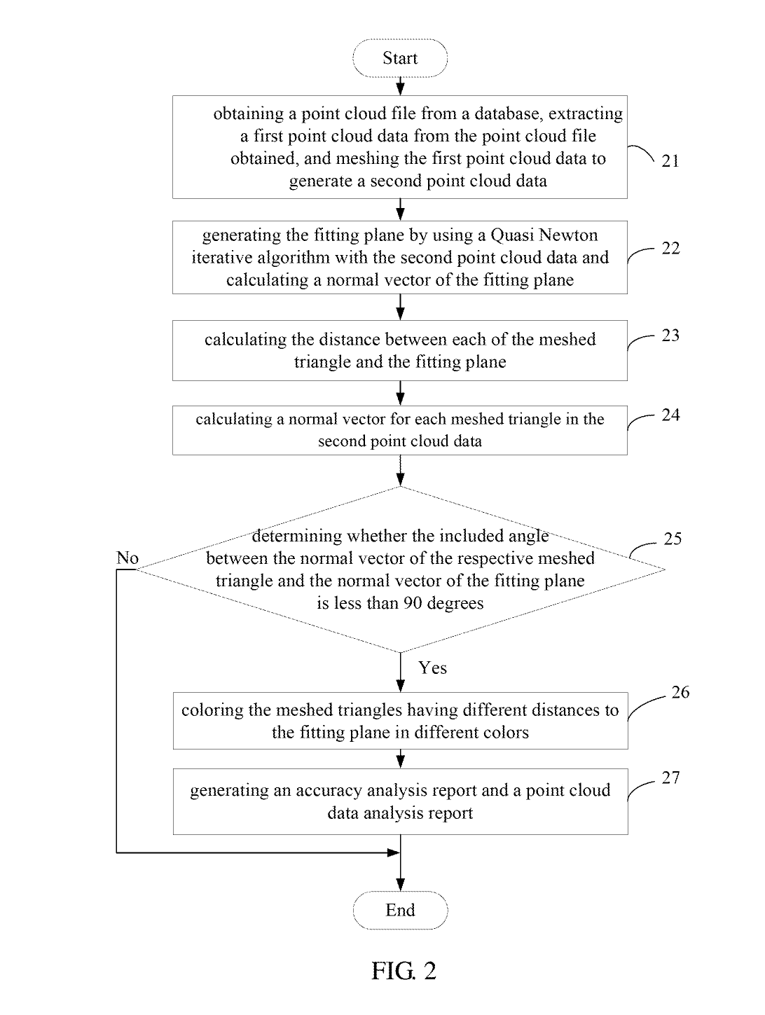

FIG. 2 in conjunction with FIG. 1 shows a flowchart illustrating a method for analyzing representational data of an object, provided in accordance to an exemplary embodiment of the present disclosure. The method depicted in FIG. 2 can be adopted by the aforementioned system 10 operating on the computing device 1. The example method shown in FIG. 2 is provided by way of example, as there are a variety of ways to carry out the method. The method generates a fitting plane with high precision based on the analysis of point cloud data using high level fitting algorithm and generates a report analyzing the accuracy of the point cloud data.

Furthermore, the illustrated order of blocks is illustrative only and the order of the blocks can change according to the present disclosure. Additional blocks can be added or fewer blocks may be utilized, without departing from this disclosure.

At block 21, the meshing module 101 obtains a point cloud file associated with an object (e.g., a manufactured or a processed product) under analysis from the database 2 via a data bus. The meshing module 101 may obtain the point cloud file by performing the file import operation. As shown in FIG. 3, which shows a schematic diagram illustrating an exemplary representation of the point cloud file provided in accordance to an exemplary embodiment of the present disclosure. The point cloud file as described previously is a file containing point cloud data corresponding to the object as measured in a coordinate system (e.g., a Cartesian coordinate system). The point cloud data recorded in the point cloud file in the instant embodiment are spatial coordinates (e.g., X-, Y-, and Z coordinates) corresponding to each point in a 2D or 3D point cloud space on a one-one basis.

The meshing module 101 reads and extracts a first point cloud data associated with the graphical representation of the object from the point cloud file using data extraction techniques. The meshing module 101 stores the point cloud data in the storage device 11.

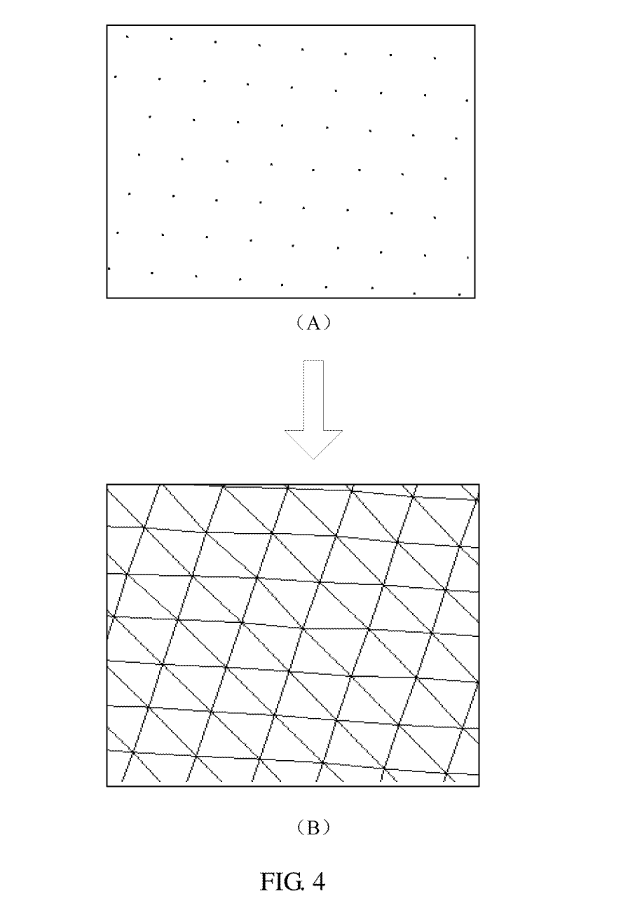

The meshing module 101 further meshes the first point cloud data to generate the second point cloud data based on a triangular meshing algorithm. In the instant embodiment, the triangular meshing algorithm is an algorithm employed to form a plurality of meshed triangles and with each of the meshed triangles formed by connecting three points that are not lying on the same straight line in the point cloud space as illustrated in FIG. 4. FIG. 4 shows a diagram illustrating a triangular meshing operation provided in accordance to an exemplary embodiment of the present disclosure. As shown in FIG. 4, points that are mapped independently in a point cloud space A are not connected in any manner to form the meshed triangles. The meshing module 101 meshes the first point cloud data in such a manner that a circumscribed circle of any meshed triangle does not include any other vertices. In other words, the meshing module 101 is configured to generate the second point cloud data (e.g., point cloud data for forming a triangular mesh network B of FIG. 4) by performing the triangular meshing operation to the first point cloud data on a basis that no other points (e.g., the fourth point or the fourth vertices) can exist in the circumscribed circle of any meshed triangle.

At block 22, the plane fitting module 101 generates a fitting plane by using a Quasi Newton iterative algorithm along with the second point cloud data, and calculates a normal vector of the fitting plane. The second point cloud data mainly consists of two parts: point cloud data (i.e., coordinate data), and vertices for the plurality of meshed triangles after meshing operation.

The method for generating the fitting plane will be described in the following paragraphs. The plane fitting module 101 first generates an initial fitting plane Plane (c, v) using the least square method (LSM) and the second point cloud data, wherein c consists of c.x, c.y, and c.z, in which, c.x represents the average value of all the x coordinate data; c.y represents the average value of all the y coordinate data; c.z represents the average value of all the z coordinate data. Then, the plane fitting module 101 calculates the normal plane associated with the actual rotated work plane Plane1 (c1, v1) through iterative calculations using the Quasi Newton iterative algorithm. The plane fitting module 101 calculates the preferable fitting position of the fitting plane by calculating the fitting position of the virtual plane iteratively using the least square method and the second point cloud data. The preferable fitting position of the fitting plane in the instant embodiment is the position where the Euclidean distance from any point of point cloud space to the fitting plane as well as the average Euclidean distance is minimized using the following iterative fitting equation, e.g., Quasi Newton non-linear equation,

$$f ( x ) = Min \sqrt{\frac{{\sum }_{R = 1}^{n} {( \sqrt{{( X 2 - X 1 )}^{2} + {( Y 2 - Y 1 )}^{2} + {( Z 2 - Z 1 )}^{2}} )}^{2}}{n} ,}$$

wherein X1, Y1 and Z1 represent the real coordinate of each point in the point cloud data; X2, Y2, and Z2 represent the real coordinate of the virtual fitting plane; n represents the total number points in the point cloud data used in the iteration.

Moreover, the plane fitting module 102 calculates the normal vector of the fitting plane based on the minimum Euclidean distances and the average of the Euclidean distances calculated between coordinate points in the point cloud data and the fitting plane.

At block 23, the distance calculation module 103 is configured to execute a distance calculation program to calculate the distance between each of the meshed triangle and the fitting plane based on the second cloud data. The distance calculation program includes the following steps. The distance calculation module 103 first obtains the coordinate data associated with three vertices corresponding to a meshed triangle according to the vertex sequence recorded in the second point cloud data. Each vertex in the second point cloud data has a serial number assigned thereto. The three vertices of each meshed triangle can be obtained according to the serial number.

Next, the distance calculation module 103 calculates the distance between each of the three vertices and the fitting plane. Suppose a point P has a coordinate of (X1, Y1, Z1), the projection of the point P onto the fitting plane AX+BY+CZ+D=0 is P′ with a coordinate of (X2, Y2, Z2), and a vector T,

$$T = - \frac{{A}^{*} X 1 + {B}^{*} Y 1 + {C}^{*} Z 1 + D}{{A}^{*} A + {B}^{*} B + {C}^{*} C}$$

then X2=X1+A*T, Y2=Y1+B*T, Z2=Z1+C*T. The distance calculation module 103 may use the Euclidean distance formula to calculate the distance d between each of the three vertices and the fitting plane. The Euclidean distance formula is provided as follow,

d=\sqrt{(X1−X2)²+(Y1−Y2)²+(Z1−Z2)²},

wherein d represents the distance between the meshed triangle and the fitting plane; X1, Y1, and Z1 represent the coordinate of point P; X2, Y2, and Z2 represent the coordinate of point P′.

The distance calculation module 103 then calculates an average distance between the three vertices of the meshed triangle and the fitting plane using Euclidean distance formula, wherein the average vertex distance is set as the distance between the meshed triangle and the fitting plane.

At block 24, the normal vector calculation module 104 calculates the normal vector for each meshed triangle. In one embodiment, the normal vector calculation module 104 may calculate the normal vector for each meshed triangle by using cross product technique. The normal vector calculation module 104 further calculate the included angle between the normal vector of each meshed triangle and the normal vector of the fitting plane.

At block 25, the normal vector calculation module 104 determines which of the meshed triangle satisfying the accuracy evaluation criterion. Specifically, the normal vector calculation module 104 determines whether a meshed triangle satisfying the accuracy evaluation criterion by determining whether the included angle between the normal vector of the particular meshed triangle and the normal vector of the fitting plane is less than 90 degree.

When the included angle between the normal vector of the particular meshed triangle and the normal vector of the fitting plane is calculated to be greater than 90 degrees indicating that the particular meshed triangle does not satisfying the accuracy evaluation criterion, the normal vector calculation module 104 neglects the particular meshed triangle and continues to analyze the neighboring meshed triangle until finishing analyzing all the meshed triangle. On the other hand, when the included angle between the normal vector of the particular meshed triangle and the normal vector of the fitting plane is calculated to be less than 90 degrees indicating that the particular meshed triangle satisfying the accuracy evaluation criterion, executes block 26.

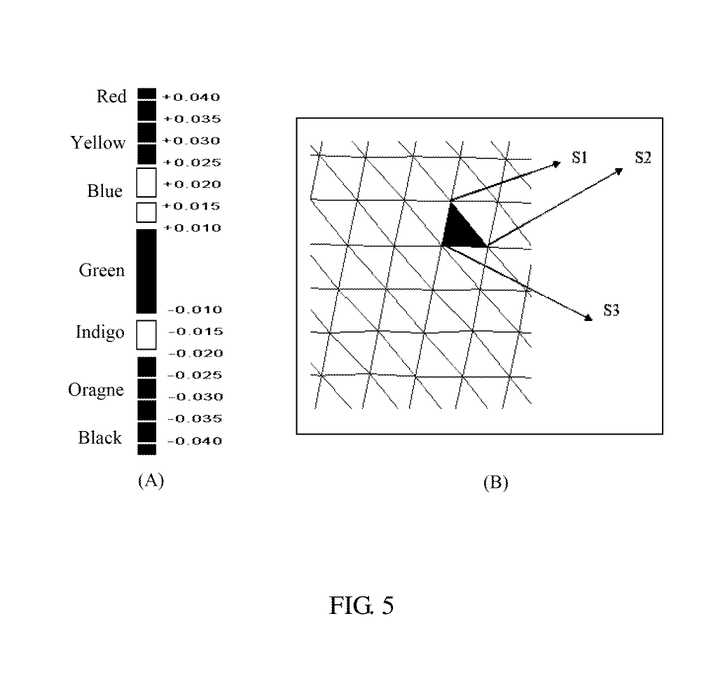

At block 26, the color-coding module 105 operatively coloring the meshed triangles satisfying the accuracy evaluation criterion in different colors based on the distance between the respective meshed triangle and the fitting plane, to indicate different accuracy levels associated with the patent cloud data. As described, the color-coding module 105 colors the meshed triangles in different colors to note different level of accuracy, hence a color gradient bar is necessary to serve as an analysis interpretation reference. The color-coding module 105 can dynamically generate the color gradient bar corresponding to different color-coding scheme used based on the user's operational needs and the point cloud information. As shown in FIG. 5, the color gradient bar may include but not limited to read, yellow, blue, light blue, green, black, indigo, and orange, with each color corresponding to a specific distance. For instance, suppose the distance between the three vertices S1, S2, S2 of a meshed triangle to the fitting plane are 0.005, 0.0047, and 0.0051, respectively, and the distance between the meshed triangle and the fitting plane is calculated to be 0.00493, the color-coding module 105 therefore will color the particular meshed triangle with the color green in accordance to the color gradient bar shown in FIG. 5.

At block 27, the report generation module 106 operatively generates an accuracy analysis report based on the color-coding results provided by the color-coding module 105 and a point cloud data analysis report based on the statistical analysis result of the second point cloud data. The accuracy analysis report includes an accuracy indication of the second point cloud data in form of color distribution. The report generation module 106 may further output the accuracy analysis report and the point cloud data analysis report to the display 13 via the data bus for the user to view and/or store the report in the storage device 11.

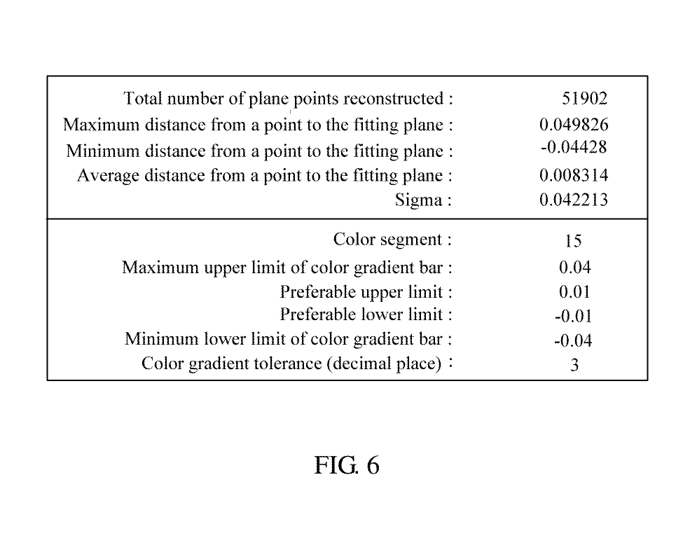

The accuracy analysis report, by using different colors to indicate different accuracy levels associated with point cloud, can provide the user with a more direct and fast way to obtain an overall understanding of the product quality and calibrate the manicuring process, accordingly. As shown in FIG. 6, the report generation module 106 in one embodiment may further include the point cloud data points having the largest distance and smallest distance to the fitting plane and the associated distances information in the point cloud data analysis report. The report generation module 106 may further include the statically analysis including but not limited to the mean and the standard deviation associated with the points in point cloud data. Particularly, the point cloud data analysis report generated may include but not limited to the total number of points in the point cloud data, spatial distance between each of the point in the point cloud data and the fitting plane, the sigma value of the fitting plane, as well as the information associated with the color-gradient bar.

It is worth to mention that the meshing module 101, the plane fitting module 102, the distance calculation module 103, the normal vector calculation module 104, the color-coding module 105, and the report generation module 106 may be implemented by programming one or more processing chips (e.g., a microprocessor or micro-controller) with necessary codes or instructions to implement corresponding algorithms.

Additionally, the present disclosure also discloses a non-transitory computer-readable medium for storing the computer executable program codes of method for analyzing graphical data of an object depicted in FIG. 2. The non-transitory computer-readable media may be a floppy disk, a hard disk, a compact disk (CD), a flash drive, a magnetic tape, accessible online storage database or any type of storage medium having similar functionality known to those skilled in the art. The codes can be read and executed by the processor 12 of the computing device 1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A system for analyzing data of an object comprising:
a meshing module configured to obtain a point cloud file corresponding to the object, extract a first point cloud data from the point cloud file, and the first point cloud data to generate a second point cloud data including coordinate data corresponding to vertices for a plurality of meshed triangles;
a plane fitting module, configured to generate a fitting plane based on the second point cloud data, and calculate a normal vector of the fitting plane;
a distance calculation module, configured to calculate the distance between each of the meshed triangles and the fitting plane;
a normal vector calculation module, configured to calculate a normal vector of each meshed triangle and determine whether each of the meshed triangles satisfies an accuracy evaluation criterion according to the normal vector of the respective meshed triangle and the normal vector of the fitting plane; and
a color-coding module, configured to operatively color each of the meshed triangles satisfying the accuracy evaluation criterion in different colors based on the distance between the respective meshed triangle and the fitting plane calculated to indicate different accuracy levels.

2. The system according to claim 1, wherein the meshing module is further configured to mesh the first point cloud data so that a circumscribed circle of any meshed triangle does not include other vertices.

3. The system according to claim 1, wherein the accuracy evaluation criterion includes determining whether an included angle between the normal vector of the meshed triangle and the normal vector of the fitting plane is less than 90 degrees.

4. The system according to claim 1, further comprising:
a report generation module coupled to the color-coding module, configured to generate an accuracy analysis report based on the color-coding result of meshed triangles and a point cloud data analysis report based on the statistical analysis result of the second point cloud data, wherein the accuracy analysis report contains the accuracy indication of the second point cloud data.

5. The system according to claim 1, wherein the fitting plane generation module is further configured to generate the fitting plane using a Quasi Newton iterative algorithm with the second point cloud data.

6. The system according to claim 1, wherein the distance calculation module is configured to calculate the distance between each meshed triangle of the second point cloud data and the fitting plane, the calculation comprises:
(a) obtaining the coordinate data associated with three vertices corresponding to a meshed triangle according to the vertex sequence recorded in the second point cloud data;
(b) calculating the distance between each of the three vertices and the fitting plane;
(c) calculating an average distance between the three vertices of the meshed triangle and the fitting plane, wherein the average distance is set as the distance between the meshed triangle and the fitting plane; and
(d) repeating steps (a) through (c) until the distance between each of the meshed triangles and the fitting plane is calculated.

7. The system according to claim 6, wherein the normal vector calculation module calculates the normal vector for each meshed triangle based on the calculation result between each of the meshed triangles and the fitting plane.

8. The system according to claim 1, wherein the color-coding module is configured to generate a color gradient bar indicating different distances between each of the meshed triangles and the fitting plane, and the color gradient includes color-coding information corresponding to meshed triangles having different distances to the fitting plane.

9. A method for analyzing graphical data of an object, executed by a computing device linked to a database, the method comprising:
obtaining a point cloud file from the database and extracting a first point cloud data from the point cloud file;
meshing the first point cloud data to generate a second point cloud data containing coordinate data corresponding to vertices for a plurality of meshed triangles;
generating a fitting plane based on the second point cloud data and calculating a normal vector of the fitting plane;
calculating the distance between each of the meshed triangles and the fitting plane;
calculating a normal vector for each meshed triangle in the second point cloud data;
determining whether each of meshed triangles satisfies an accuracy evaluation criterion according to the normal vector of each respective meshed triangle and the normal vector of the fitting plane; and
coloring each of the meshed triangles satisfying the accuracy evaluation criterion in different colors based on the distance between each respective meshed triangle and the fitting plane to indicate different level of accuracy.

10. The method according to claim 9, further comprising:
meshing the first point cloud data in such a manner that a circumscribed circle of any meshed triangle does not include any other vertices.

11. The method according to claim 9, wherein the accuracy evaluation criterion comprises determining whether an included angle between the normal vector of the respective meshed triangle and the normal vector of the fitting plane is less than 90 degrees.

12. The method according to claim 9, wherein the step of coloring the meshed triangle satisfying the accuracy evaluation criterion comprises:
coloring the meshed triangle having the included angle between the normal vector of the meshed triangle and the normal vector of the fitting plane being less than 90 degrees in different colors based on the distance between the respective meshed triangle and the fitting plane calculated.

13. The method according to claim 9, further comprising:
generating an accuracy analysis report based on the color-coding result of the meshed triangles and a point cloud data analysis report based on the statistical analysis of the second point cloud data, wherein the accuracy analysis report contains accuracy indication of the second point cloud data.

14. The method according to claim 9, wherein the step of generating the fitting based on the second point cloud data comprises:
generating the fitting plane by using a Quasi Newton iterative algorithm with the second point cloud data.

15. The method according to claim 9, wherein the step of calculating the distance between each meshed triangle and the fitting plane comprises:
(a) obtaining coordinate data associated with three vertices corresponding to a meshed triangle according to the vertex sequence recorded in the second point cloud data;
(b) calculating the distance between each of the three vertices and the fitting plane;
(c) calculating an average distance between the three vertices of the meshed triangle and the fitting plane, wherein the average distance is set as the distance between the meshed triangle and the fitting plane; and
(d) repeating steps a) through c) until the distance between each of the meshed triangles and the fitting plane is calculated.

16. The method according to claim 9, wherein the step of calculating the normal vector for each meshed triangle in the second point cloud data comprises:
calculating the normal vector for each meshed triangle based on the calculation result between each of the meshed triangles and the fitting plane.

17. The method according to claim 9, further comprising:
generating a color gradient bar indicating different distances between meshed triangles and the fitting plane, wherein the color gradient bar contains color-coding information corresponding to meshed triangles having different distance to the fitting plane.

18. A non-transitory computer-readable storage medium storing a set of instructions, when executed by at least one processor of a computing device, causes the at least one processor to perform a method for analyzing data of an object, the method comprising:
obtaining a point cloud file from the database and extracting a first point cloud data from the point cloud file;
meshing the first point cloud data to generate a second point cloud data containing coordinate data corresponding to vertices for a plurality of meshed triangles;
generating a fitting plane based on the second point cloud data and calculating a normal vector of the fitting plane;
calculating the distance between each of the meshed triangles and the fitting plane;
calculating a normal vector for each meshed triangle in the second point cloud data;
determining whether each of meshed triangles satisfies an accuracy evaluation criterion according to the normal vector of the respective meshed triangle and the normal vector of the fitting plane; and
coloring each of the meshed triangles satisfying the accuracy evaluation criterion in different colors based on the distance between the respective meshed triangle and the fitting plane to indicate different level of accuracy.

19. The non-transitory computer-readable storage medium according to claim 18, wherein the step of determining whether each of meshed triangles satisfies the accuracy evaluation criterion comprises:
determining whether an included angle between the normal vector of the respective meshed triangle and the normal vector of the fitting plane is less than 90 degrees.

20. The non-transitory computer-readable storage medium according to claim 18, wherein the method further comprises:
generating an accuracy analysis report based on the color-coding result of the meshed triangles and a point cloud data analysis report based on the statistical analysis of the second point cloud data, wherein the accuracy analysis report contains accuracy indication of the second point cloud data.
